(19) United States
(12) Patent Application Publication
(10) Pub. No.: US 2008/0319866 A1
(43) Pub. Date: Dec. 25, 2008

(54) METHOD AND SYSTEM TO HAND OVER AN ONLINE TRANSACTION TO A HELP DESK ASSISTANT

(75) Inventors: Dominique Papi, Porto Vecchio (FR); Jean Mouyade, La Roquette Sur Siagne (FR); Christophe Sebti, Cagnes Sur Mer (FR)

Correspondence Address: YOUNG & THOMPSON, 209 Madison Street, Suite 500, ALEXANDRIA, VA, 22314, US

(73) Assignee: AMADEUS S.A.S., SOPHIA ANTIPOLIS BOIT (FR)

(21) Appl. No.: 11/765,512

(22) Filed: Jun. 20, 2007

(51) Int. Cl. G06Q 30/00

(52) U.S. Cl. 705/26

(57) ABSTRACT

A method of providing assistance to an end-user of an online software application running from a web server. While the end-user and the web server communicate through at least one data network, during a web session initiated by the end-user from a client software application, the online software application provides a manner of requesting assistance from a help desk on at least one of the web page returned to the client application. When the end-user activates the manner of requesting assistance he/she obtains from the server of the online software application a keyword associated to the web session. End-user further obtains at least one telephone number of the help desk to call. When the end-user is calling the help desk through a telephone network the keyword is communicated to an assistant. After the assistant has successfully logged in to the web server the web session initiated by the end-user is shared with the assistant. Then, a transaction in progress with the online software application can be handed over to the assistant who will complete it on behalf of the end-user.

### FIELD OF THE INVENTION

The present invention relates generally to help services provided to end-users of online applications. It more particularly refers to a method and a system where a help desk assistant takes over web sessions to complete transactions on behalf of end-users experiencing difficulties upon requests received through an alternate voice channel.

### BACKGROUND OF THE INVENTION

The considerable development of all sorts of private computer networks (i.e., company, institution, corporate and such networks) and their interconnection through a global public network (i.e., the Internet) has triggered the development of countless software applications serving many purposes. Essentially based on the world-wide client-server distributed information retrieval model of the Internet, simply referred to as the web, applications are run on remote servers, under the form of web sites, accessible through client applications (referred to as web browsers or navigators) of end-users from all over the world. These web sites are offering a large scope of services ranging from the simple delivery of information to highly interactive sophisticated applications that have been made possible with the evolution and improvements brought over the years to the web hypertext transport protocol (HTTP) and to the associated hypertext markup language (HTML) used to encode the documents web sites deliver (i.e., web pages). This includes all the techniques and tools implemented both in server and/or client sides to make possible what is broadly referred to as dynamic web.

Online commercial applications, where providers of goods and services are selling their products, are among the most sophisticated of these interactive applications. Also, highly interactive sites are now deployed by administrations, government agencies and official institutions to complete complex administrative tasks including, e.g., electronic filing of income tax forms along with their online payment. It is especially important for those sites to keep their interfaces as simple as possible, so that most of their end-users are actually able to use them effectively, while keeping them secure and reliable as well. End-users can thus trust them enough to accept that financial transactions be also completed through the same channel. This must be achieved often in spite of the inherent complexity of the transactions.

As an example of this, many travel service providers and airline companies have their own web sites from which travelers can book and pay directly a trip without having to visit a travel agency. If many travel transactions are straightforward to complete and consist only in first entering in the appropriate fields the information that would be otherwise provided orally to a travel agent, others are more complex. Indeed, a departure and a destination city for an air ticket and the corresponding travel dates are generally sufficient to obtain from the selected web site a list of travel opportunities, generally sorted by price, from which site end-user is expected to exercise a choice. Then, once identifications of travelers have been provided and a means of payment selected booking can be automatically completed. This kind of transaction does not require any particular skill other than what is normally expected from the casual user of any web site. Travel service providers cannot however afford to ignore travelers having more sophisticated requests that cannot be handled simply under the penalty of loosing part of their customers and revenue. In the field of the airline industry special requests are, among numerous similar examples, travelers requesting special meals to be served on board of long-haul flights, those traveling with very young children and infants or the ones that are affiliated to a particular fidelity program and would like to take advantage of the mileage points they have accumulated in a certain way. In an attempt to keep their web site interface as simple as possible, still satisfying the majority of their users, web sites are generally however designed to ignore most, if not all, of these legitimate special requests though. Special requests, beyond what web site has been designed to support, must then be handled completely through another channel. This is very poorly supported though. For example, first, end-user may have to find on the web site the telephone number of a help desk or call center to get an assistant. Then, end-user must attempt to explain the problem encountered to the assistant. This implicitly requires that current transaction be aborted and restarted from the very beginning by the assistant in lieu of the end-user to have, e.g., his/her special request handled, if assistant has indeed the proper means and rights to do it in place of the end-user him/herself. Other web sites are providing an even more rudimentary kind of assistance under the form of an E-mail address to which end-user is expected to send questions and report problems. In this case also transaction must be aborted. Moreover, it must be postponed until a satisfactory answer is provided, if any is ever provided, that would allow to properly interact with the software application if indeed possible through the sole user interface of the application.

In other instances end-users may not have special requests but experience problems because, e.g., of a particular configuration of their client software or machine they are using or just because they are unfamiliar with the application they interface with. If they cannot find anything that solves their problem from the help menus that are generally provided with any software application end-users have also to call the help desk. As above, the problem encountered must then be thoroughly explained over the phone while assistant is trying to reproduce it, if possible, in order to provide the requested help and/or to do the transaction on behalf of the end-users.

Therefore, there is a general need to provide to end-users of online software applications a help service much more efficient than the traditional kind of help service here above described. More particularly, highly interactive complex software applications of the kind deployed in the travel industry by online travel service providers, airline companies and global distribution systems (GDS's) to book and buy trips may optionally need to handle a huge numbers of options and parameters that cannot be all accommodated while keeping client interface simple enough for the casual user. Hence, it would be advantageous to have a method and a system that would enable assistants of a help desk supporting such a travel application to have the possibility of simply and quickly share web sessions of their end-users requesting assistance. Alternatively, it would be also advantageous to let assistants taking over the web sessions opened by end-users expressing special needs, or experiencing difficulties. When requested to provide assistance through an alternate telephone, network assistants would then help end-user completing their transactions, or would complete them on their behalf, while only requiring end-users to communicate a drastically limited amount of information to retrieve all the session-specific and contextual data of the pending transactions.

### SUMMARY OF THE INVENTION

The method and system of the present invention meet the above needs and describe how assistance to an end-user of an online software application running from a web server is provided. While the end-user and the web server communicate through at least one data network, during a web session initiated by the end-user from a client software application, the online software application provides a means for requesting assistance from a help desk on at least one of the web page returned to the client application. When the end-user activates the means for requesting assistance he/she obtains from the server of the online software application a keyword associated to the web session. End-user further obtains at least one telephone number of the help desk to call. When the end-user is calling the help desk through a telephone network the keyword is communicated to an assistant. After the assistant has successfully logged in to the web server the web session initiated by the end-user is shared with the assistant. Then, a transaction in progress with the online software application can be handed over to the assistant who will complete it on behalf of the end-user.

It is therefore an object of the present invention to facilitate the handover to the help desk of a transaction when the end-user of an online software application is experiencing difficulties, or has special requests, by requiring the sole communication of a keyword allowing assistant to quickly retrieve the web session in order to help end-user or to complete the transaction on his/her behalf.

Further objects, features and advantages of the present invention will become apparent to the ones skilled in the art upon examination of the following description in reference to the accompanying drawings. It is intended that any additional advantages be incorporated herein.

### BRIEF DESCRIPTION OF THE DRAWINGS

FIG. 1 describes through a typical example the overall environment in which the invention better takes place.

FIG. 2 illustrates how assistance is requested from the help desk supporting the software application run from the server.

FIG. 3 discusses how reservation is handed over to an assistant of the help desk.

FIG. 4 describes the steps of the handover method of the invention.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention.

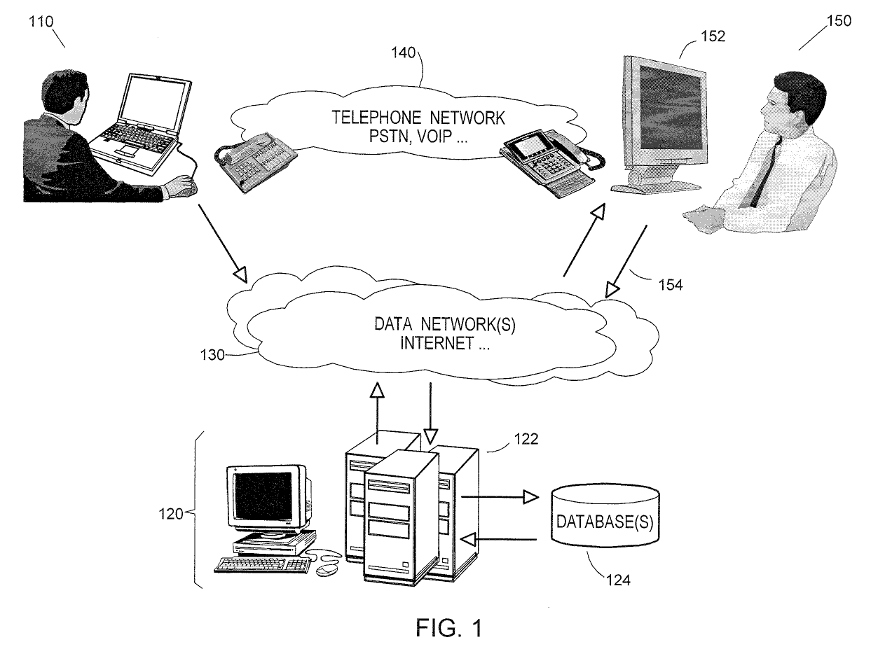

FIG. 1 describes through a typical example the overall environment in which the invention better takes place. The software application that remote end-users (110) are accessing is run from a web server (120). The computing resources associated with the web server can take many forms possibly ranging from a single computer to the large redundant cluster of engines (122) that are generally put in place, e.g., in the travel industry, by the providers of travel services such as the GDS's mentioned above. Associated with the computing resources there are ample storage means holding large, sometimes huge, amount of data most often in structured databases (124). Databases are used to hold and quickly retrieve all the information necessary to serve the remote clients of the software applications. For example, databases hold the schedules and fares of all airline companies so that the kind of travel software application considered by the invention can handle simultaneously many concurrent end-user requests inquiring for travel opportunities. Requests are received through a communication network generally including a combination a private and public networks like the world-wide Internet (130). Typically, such a system is made capable of operating in a 24 hours a day, 7 day a week, mode simultaneously serving hundreds and even, for the largest, thousands of requests.

As discussed in the background section assistance is provided to the end-users (110) experiencing difficulties upon request. According to the invention assistance requests are issued through an alternate voice channel (140). This may be achieved through the traditional public switched telephone network (PSTN). However, phone calls can be placed as well through newer voice networks such as the cellular phones or directly from end-user personal computers (PC's) and specialized phone boxes over data packet networks like the Internet implementing, e.g., the voice over IP (VOIP) protocol. Generally, the voice channel (140) is thus a combination of any number of telephone networks made capable of interfacing with each other to reach the help desk (150) put in place by the provider of the software application(s) running from the server (122).

Assistants of the help desk (150) have their own access (154) to the server resources (122) and databases (124) used to serve the end-users of the application(s) through the combination of networks already discussed (130). Typically, help desk and call centers are also, like end-users, remotely located from the server but have privileged accesses to all the server resources and have the necessary display facilities (152) to handle end-user requests.

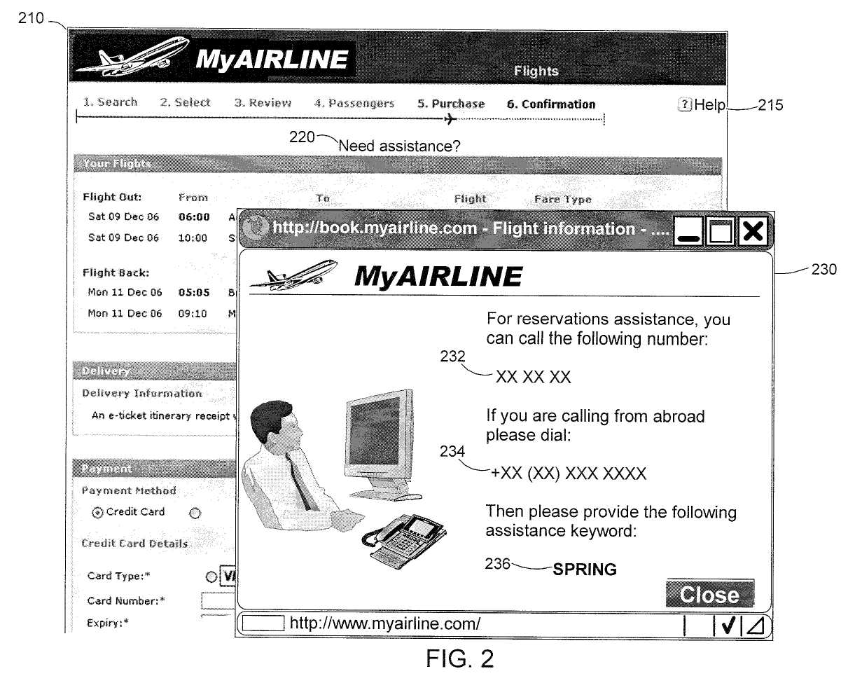

FIG. 2 illustrates how assistance is requested from the help desk supporting the software application run from the server. Although invention is exemplified in this figure through a travel application aimed at booking and buying airline tickets it must be obviously understood that it can apply as well to all sorts of interactive software applications; e.g., those put in place by other providers of services and goods, or by official and business sites to complete online complex administrative tasks and financial transactions.

Online travel service providers can indeed observe that a very significant fraction of their remote users are facing problems in the course of making a trip reservation online; especially, during the booking and payment phases. Problems encountered cannot be generally overcome without a human intervention. Therefore, as discussed in the background section, booking is abandoned and end-user forced to find an alternate way of restarting its reservation from the very beginning through another channel i.e., completely over the phone, by visiting a travel agency, etc. The end-user is therefore frustrated and service provider has failed achieving its objective of providing an efficient and inexpensive way of selling its services online, moreover, with the high risk of loosing a customer. Problems encountered in the example of an airline selling air-tickets are first because the functionality corresponding to what end-user is willing to do has not been made available online. They can be of many kinds. On top of what has been already briefly discussed in the background section following situations are exemplary potential source of problems that may require a human intervention. Travel web site interfaces, designed to be as simple as possible, yet satisfying a majority of their end-users, are not normally able to handle, e.g.: the case of children traveling alone, the case of split payment transactions (i.e., full payment effected with more than one method; e.g.: from two separate credit cards), if a traveler requires physical assistance to get on board or while traveling: wheelchair, handicapped and vision-impaired peoples, etc. Also, technical problems such as: server outage, sub-system link down, credit card rejection, payment method not available online are a frequent source of problems. Finally, it is not infrequent that end-user does not completely trust the web site interface and refuses to communicate payment information online even though a secured session has been activated.

FIG. 2 shows an exemplary web page (210) returned during the process of booking an air trip online. Although booking process is near completion end-user has still a special, yet legitimate, request (e.g., any of the ones here above listed) it cannot however accommodate. For the reason mentioned above, i.e., to keep application user interface simple the corresponding option has not been made available online. This situation, where end-user would normally end up abandoning the online transaction (since, even though what is proposed may be overall satisfactory, request cannot be completely satisfied) can be overcome with a web site according to the invention. Such a web site provides, on top of the traditional contextual help page (215), the possibility of requiring assistance of a human-being. Hence, all pages returned to the client application (i.e., the web browser or navigator), or part of them, include a hyperlink asking if assistance is needed (220).

Then, when clicked, hyperlink triggers the display of a pop-up window, an example of which is shown (230). A unique keyword (236) corresponding to the current session is provided in window so that the assistant, when called through the telephone network shown in FIG. 1 will be able to retrieve and share the session from the server at the exact point where it has been left by the end-user experiencing difficulties or having requests not manageable from the online interface of the software application. Optionally, as shown, window also displays at least one telephone number (232, 234) to reach the appropriate help desk and get an assistant to help completing the transaction from the point currently reached by the end-user of the application. Alternatively, help desk phone number(s) can be provided in at least one, and possibly all, other pages returned to the client software application.

Keyword is the unique identification of the user session. It is generated from the database and server shown in FIG. 1 (120). It is the entry key for all the stored contextual information regarding the current state of the end-user session.

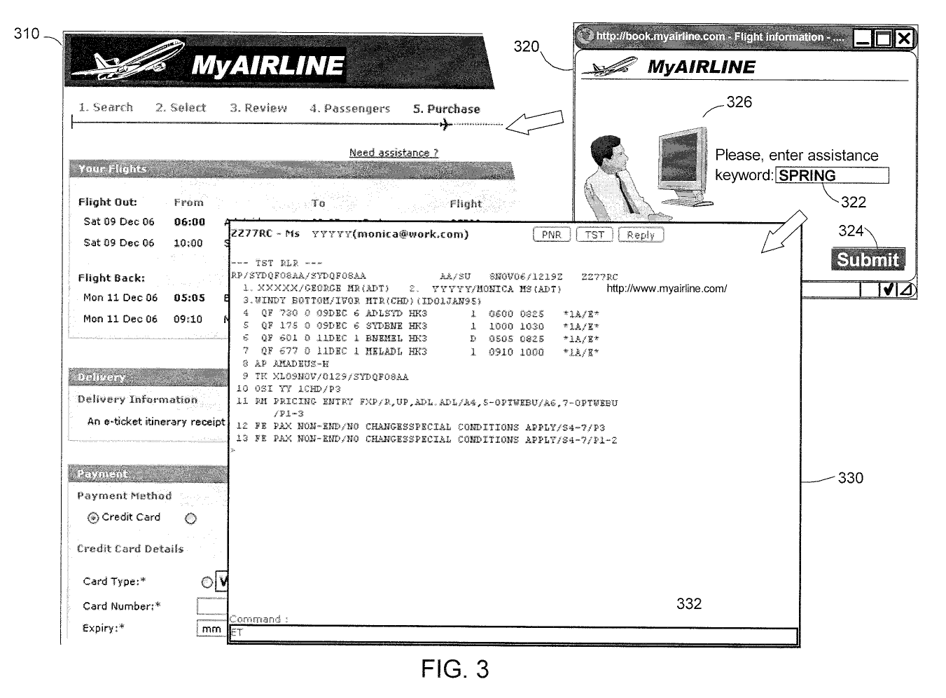

FIG. 3 discusses how reservation is handed over to an assistant of the help desk.

When end-user of a web site according to the invention decides he/she cannot proceed with current booking, e.g., for any of the reasons mentioned above, he/she has to call the appropriate help desk phone number provided in pop-up window as explained in FIG. 2. The keyword that was also automatically generated by the server at the time assistance hyperlink was clicked is then communicated over the phone to the assistant (326) designated by the help desk to assist end-user as soon as this latter becomes available. This is the only piece of information that needs to be communicated to the assistant.

Access to the help desk interface of the supported software application is restricted to the help desk members that must first provide the usual credentials, generally a user identification (ID) and a corresponding password, to be authorized to intervene in end-user sessions. Once done, help desk interface display a form window (320) in which assistant can enter, e.g., in a standard input box (322), the keyword provided by the end-user over the phone. Keyword can be entered manually. Alternatively, assistant may have also access to the list of all keywords currently in use (all pending keywords that have been generated in response to assistance requests received from end-users) from which the keyword can be copied and pasted.

When form is submitted (324) assistant is then directed to the exact same web page (310) that was displayed to the end-user when he/she decided to require assistance from the help desk. Thus, assistant in charge needs not to be communicated any other contextual information about the user session. This dramatically expedite the standard handover procedure in which a end-user must first find the help desk number then, after having obtained an assistant, must explain from the very beginning all he/she wanted to do and what was the problem encountered. For a travel booking application of the kind chosen to illustrate the invention end-user has thus to communicate over the phone all information on itineraries and passengers: schedules, flight numbers, fares, passenger names and titles, frequent flyer numbers, etc. This must be done even though this information was already provided to the web site and in spite of the fact that transaction may have almost completed except for some details or special requests that could not be handled online. Moreover, the help desk has to create a new reservation (since the web session is abandoned) and has to communicate it back to the online user in one way or another to confirm the trip.

On the contrary, with a web site according to the invention, the assistant can immediately complete the transaction on behalf of the end-user once he/her has been explained the reason of the call to the help desk. If the problem encountered is a minor one it can be handled through the standard user interface by the assistant or the end-user. This is generally the case of an inexperienced user which may just not be enough familiar with the interface of the software application to complete the transaction himself/herself. However, if end-user has a special legitimate request which cannot be handled through the regular user interface, the assistant, a skilled travel assistant familiar with all the options, possibilities and limitations of the software application involved, can open a help-desk specific interface window. Although a graphic user interface (GUI) could be used, as it is a standard practice for the user interface, opened window (330) is preferably a command line interface or CLI (332). Indeed, a CLI is generally preferred when a large vocabulary of commands combined with a wide range of options have to be considered as it is the case with the travel application chosen to illustrate the invention and with many other commercial or administrative interactive applications. Commands, that are generally obscure short strings of characters, must be all remembered (with all their parameters) by the assistants. Hence, the name of cryptic mode sometimes used to qualify this way of interfacing with an application. However, a skilled assistant can be much more efficient and can enter more rapidly commands as text than with a GUI. Therefore, special requests and other problems that cannot be handled from the user interface can be quickly accommodated by the assistant from its dedicated interface, be it a CLI or anything else, allowing to control all the features of the supported software application.

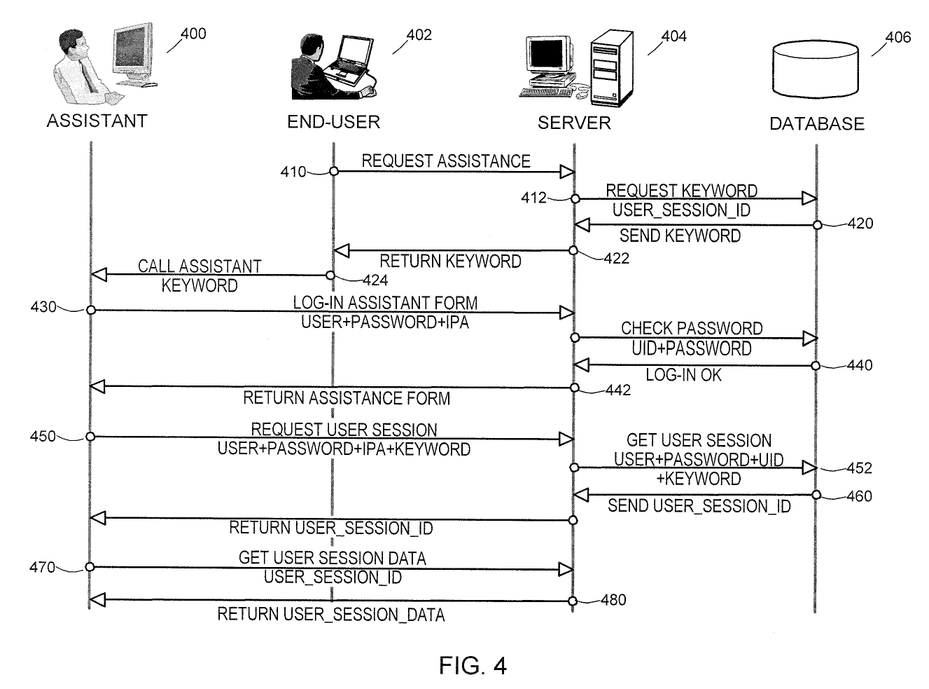

FIG. 4 describes the steps of the handover method of the invention.

Assistance request (410) is initiated by the end-user (402) of a software application under the form of a HTTP request. Request is forwarded to server (404) running the application as soon as end-user clicks on the corresponding hyperlink of the web page from where difficulties are encountered. Then, a new unique keyword (among all keywords currently in use for supporting end-users of application) is requested (412) from the database shown in FIG. 1 (406). Thus, keyword is now on associated to the session currently opened between client browser and server software application and identified by a session user ID. Keyword is sent back to server (420) which forwards it immediately to end-user client browser (422) so that browser can display it along with the telephone assistance number(s) to call as shown and discussed in FIG. 2.

End-user, knowing which keyword to provide and what telephone number to call, can decide to initiate a phone call (424) any time after. As previously discussed, this can be done through any type of telephone or data network capable of transporting voice. Then, end-user needs only to communicate keyword over the phone to the assistant committed by help desk to handle end-user problem. At this point assistant has enough information to login into server application (430). Login step is also described in FIG. 3. Assistant is assumed to show enough credentials to meet security rules of the server and of the supported software application (e.g., assistant ID, password). Checking of the assistant credentials may optionally include checking that assistant IP (internet protocol) address is indeed within the predefined range of addresses of the help desk. Once assistant credentials have been checked against what is stored in database (406) login to server is complete (440). Server application then returns to client application of the assistant an electronic form to fill (442) in which keyword, that has been communicated over the phone by the end-user requiring assistance, must be entered by the assistant. Once filled, form is sent back to server (450) along with all the necessary information to retrieve the end-user session ID from the server and associated database (452). This includes the IP address generally dynamically attributed to the end-user by an Internet service provider at login. Further optional checking of the validity of the assistance request consists in verifying that provided keyword actually belongs to the list of keywords stored in database. Then, server in conjunction with database can return to the assistant the user session corresponding to the initial assistance request (410). Optionally, depending on the application, web session initiated by the end-user and shared with the help desk can be a secured HTTP transaction (HTTPs).

At this point assistant can decide to get (470) the data, i.e., the web page, from where end-user has decided to request assistance. Once web page is returned (480) to the assistant this latter can help end-user finishing the transaction. Assistant can also decide to complete the pending transaction on behalf of the end-user either through the regular user interface or through the assistant dedicated interface allowing to fully exploit all possibilities of the software application in order to completely satisfy end-user request.

1. A method of providing assistance to an end-user (110) of an online software application running from a web server (120), the end-user and the web server communicating through at least one data network (130) the method comprising:
during a web session initiated by the end-user from a client software application with the online software application,
providing on at least one of the web page (210) returned to the client application of the end-user by the online software application a means for requesting assistance (220) from a help desk (150);
when the end-user is activating the means for requesting assistance,
obtaining from the server of the online software application a keyword associated to the web session initiated by the end-user (236);
when the end-user is calling the help desk through a telephone network (140),
communicating to an assistant (326) of the help desk the keyword;
after the assistant has successfully logged in to the web server (324),
sharing the web session initiated by the end-user with the assistant (310);
handing over to the assistant the completion of a transaction in progress with the online software application on behalf of the end-user (330).

2. The method of claim 1 wherein the step of obtaining from the server of the online software application a keyword further includes obtaining at least one telephone number (232, 234) of the help desk to call.

3. The method of claim 1 wherein the step of handing over to the assistant the completion of a transaction is replaced by the step of helping end-user completing the transaction him/herself through a regular user interface (210).

4. The method of claim 1 wherein the step of handing over to the assistant the completion of a transaction further includes opening a dedicated assistant interface (330) accepting an exhaustive list of commands and parameters aimed at thoroughly controlling the online software application.

5. The method of claim 4 wherein the dedicated assistant interface is a command line interface (332).

6. The method of claim 1 wherein the step of handing over to the assistant the completion of a transaction is replaced by the step of providing help to the end-user experiencing difficulties using the online software application or having problems with the software or hardware environment of the client software application.

7. The method of claim 1 wherein the means for requesting assistance (220) is a hyperlink to the online software application to perform the association of the web session initiated by the end-user with the keyword and wherein the keyword is returned in a web page (230) to the client software application of the end-user.

8. The method of claim 7 wherein at least one telephone number of the help desk to call is further returned to the client software application of the end-user.

9. The method of claim 7 wherein the keyword is obtained from a database (124) controlled by the online software application.

10. The method of claim 1 wherein the success of the login to the web server (320) from the help desk is contingent upon the assistant providing expected credentials.

11. The method of claim 10 wherein providing the expected credentials include providing an assistant identification, a password and the keyword (322).

12. The method of claim 10 wherein providing the expected credentials further includes checking that IP address of the assistant belongs to a pre-defined range of IP addresses and checking that keyword belongs to the set of keywords stored in the database.

13. The method of claim 1 wherein the web session initiated by the end-user from a client software application with the online software application is a secured web session.

14. A system for serving remotely located end-users (110) of an online software application through at least one data network (130) and for providing assistance to the remotely located end-users upon requests received through a telephone network (140) to a help desk (150) supporting the online software application, the system comprising:
a web server (120) including computing resources (122) and providing access to at least one database (124);
a computer program product stored on a readable storage medium of the computing resources comprising computer readable code means for causing at least one computer to operate the method of handing over an online transaction to an assistant of the help desk according to claim 1.
